(19) United States
(12) Patent Application Publication
(10) Pub. No.: US 2024/0393036 A1
(43) Pub. Date: Nov. 28, 2024

(54) A TEMPERATURE CHANGE DETECTION METHOD AND SYSTEM OF COMPRESSOR-BASED REFRIGERATION SYSTEMS

(71) Applicant: EATON INTELLIGENT POWER LIMITED, Dublin (IE)

(72) Inventors: Chahrazed BOUHINI, Dublin (IE); Neil BROCKETT, Ballybunion (IE)

(21) Appl. No.: 18/694,698

(22) PCT Filed: Nov. 15, 2021
(86) PCT No.: PCT/EP2021/081752

§ 371 Date: Mar. 22, 2024

(51) Int. Cl. F25D 29/00; G08B 21/18

(52) U.S. Cl. CPC F25D 29/008; F25D 2700/12; G08B 21/182

(57) ABSTRACT

Some embodiments relate to a temperature change detection method with a compressor. The method comprises acquiring, via a circuit breaker of the compressor, power data associated with the compressor, wherein the power data relates to temperature states of the compressor. The method further comprises constructing a feature space using the acquired power data; determining feature vectors within the feature space; classifying, via a classifier, the temperature states based on the feature vectors of the feature space; determining a temperature change based on the classified temperature states; and notifying a user of a detected temperature change.

### CROSS-REFERENCE TO RELATED APPLICATIONS

This application is a national phase filing under 35 C.F.R. § 371 of and claims priority to PCT Patent Application No. PCT/EP2021/081752, filed on Nov. 15, 2021.

### FIELD OF DISCLOSURE

The field of this disclosure relates to identifying and detecting a state of change in temperature in compressor-based refrigeration systems. In particular determining a change in temperature related to a breach in a seal of a cold enclosure of the compressor-based refrigeration system based on the compressor power data.

### BACKGROUND

Compressor-based refrigeration systems, in both domestic and industrial applications, often suffer from increased power consumption whenever there is a break in the closed cooling environment, for example when a door is left open or a seal of an enclosure has malfunctioned. The increased power consumption is a result of the increase in temperature within the cool enclosure environment, as the higher external temperature leaks into the cooling enclosure. The compressor has to work harder, i.e. consume more power, to maintain the desired cold temperature level. In current refrigeration systems independent active sensors have to be installed into the cooling appliance or controlled storage environment, such as a domestic refrigerator, industrial cool room or chilled logistics container, in order to detect if there is a change in temperature-state. These active sensors are connected to the appliance or controlled storage environment in order to detect that a door has been left open, and commonly include audio signals to notify a user that a detection has been made.

These commonly used active sensors require a power supply to operate, and thus increase the overall power consumption of the appliance or environment. Although, in some cases this increase in power can be substantial if several sensors are required, such as in a controlled storage facility with several cooling environments. Further, adding active sensors to cold store appliances or environments requires an extra manufacturing step, extra material for creating the sensors and thus extra cost. Also, if the active sensor(s) break or fail to detect a door has been opened, there is no immediate way to know that such has occurred. Furthermore, as mentioned above, the common notification output is an audio signal which is of little use if it cannot be heard, or if a user has reduced hearing or some hearing disability. Even with the increase in Internet of Things (IoT) type appliances, which can send electronic notifications to an external device, the appliance has to be retrofitted to include this function.

Therefore, there is a need to provide an integrated temperature detection solution to all closed cooling environments, new and old, to easily and quickly detect if a door to the closed environment has been left open or a seal of an enclosure has malfunctioned.

### SUMMARY

The proposed method and system helps detect the change in temperature caused by a door being left open or a seal malfunctioning in an enclosed cold environment, leading to the appliance or chilled storage compressor changing its energy consumption behaviour in a domestic refrigerator, industrial refrigerator, industrial cooling room, chilled logistics container, etc.

The method and system proposed includes a real time notification system to allow the user to take actions due to a potential door left opened accidentally or a seal malfunctioning. Previously proposed solutions, in this domain, relied heavily on using additional independent active sensors to detect if the refrigerator door (cool enclosure, controlled storage environment, chilled logistics container, etc.) was left open for several minutes/hours. This disclosure provides an efficient technical solution using integrated power reading data only. Thus, it can be applied to new and existing cold appliances or environments.

In an aspect of the disclosure there is provided a temperature change detection method with a compressor, the method comprising: acquiring, via a circuit breaker of the compressor, power data associated with the compressor, wherein the power data relates to temperature states of the compressor; constructing a feature space using the acquired power data; determining feature vectors within the feature space; classifying, via a classifier, the temperature states based on the feature vectors of the feature space; determining a temperature change based on the classified temperature states; notifying a user of a detected temperature change.

In some embodiments, the compressor may be part of a refrigeration system and the refrigeration system may be part of a cold enclosure.

The acquisition of the power data of the compressor may comprise acquiring one or more of: current data; voltage data; calculated power data; and/or calculated energy data. Acquiring this data allows for the change in compressor state to be determined and thus correlated with a change in temperature state.

The power data may be pre-processed before constructing the feature space, wherein the pre-processing may comprise determining the active power, reactive power and/or derivative power. The derivative of power helps to detect steady states and transitions within the feature space.

In some embodiments, the classifier may be an online classifier. The use of an online classifier allows real time classification to be executed, i.e. the system can classify on the fly and does not have to be a trained classifier embedded into the refrigeration system at the circuit breaker or appliance level.

In some embodiments, the determining if a temperature change has occurred may relate to a breach in a seal of a cold enclosure. For cold enclosures that are in a remote location or that are not accessed on a regular basis, the disclosed method and system allows for early detection of a breach in the seal of the cold enclosure which would otherwise be left undetected until a user accesses the cold enclosure. A notification system notifies the user when a change in power value from the compressor data is detected, indicating a breach in a seal.

The notification may be executed after a predetermined time threshold. Having a predetermined threshold allows for the user to only be notified once the time threshold has been met and not every time a door is opened and closed to a cold enclosure.

The predetermined time threshold may be defined by a user. The user may choose a time threshold according to the particular application that requires the detection of a temperature change.

Notifying a user that a temperature change has been detected may comprise: sending an electronic message to an external device; sounding an alarm; turning on a light; and/or providing mechanical means to reseal the cold enclosure.

In an aspect of the disclosure there is provided a temperature change detection system, the system comprising: a compressor; a circuit breaker of the compressor; an acquisition component; an external computing component, wherein the external computing component is configured to: acquire, via a circuit breaker of the compressor, power data associated with the compressor, wherein the power data relates to temperature states of the compressor; construct a feature space using the acquired power data; determine feature vectors within the feature space; classify, via a classifier, the temperature states based on the feature vectors of the feature space; determine a temperature change based on the classified temperature states; notify a user of a detected temperature change.

The system may further comprise a plurality of power sensors, wherein the plurality of power sensors may be configured to measure the power data of the compressor.

The system may further comprise a communication component, wherein the communication component may be configured to transmit the power data to an external device. Transmitting the data to an external device allows for further data analysis to be performed.

In some embodiments, the external computing component may be an edge device or a remote server.

The external computing component may comprise: a pre-processing module; a classifier module; a notification module.

### BRIEF DESCRIPTION OF THE DRAWINGS

The disclosure will be described, by way of example only, with reference to the accompanying drawings, in which:

FIG. 1 is a schematic diagram of the system components;

FIG. 2 is a flow diagram of the method steps for identifying and detecting a state of change in temperature in compressor-based refrigeration systems using an integrated approach;

FIG. 3A is an example plot of the current over time for a refrigerator appliance where the temperature state changes;

FIG. 3B is an example plot of the power over time for a refrigerator appliance where the temperature state changes;

FIG. 4 is an example feature space plot constructed from the power data of a refrigerator appliance showing the different temperature states; and

FIG. 5 is a flow diagram of the transfer learning method steps for determining the temperature change state of an unknown refrigerator appliance.

### DETAILED DESCRIPTION

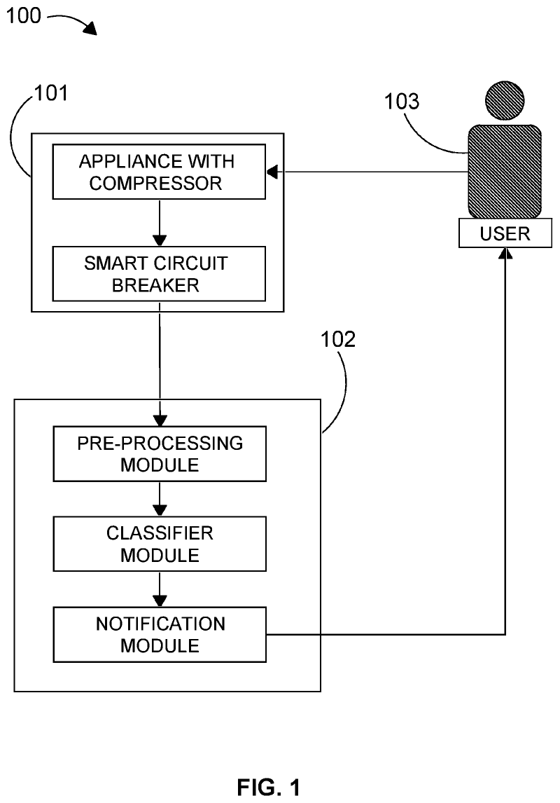

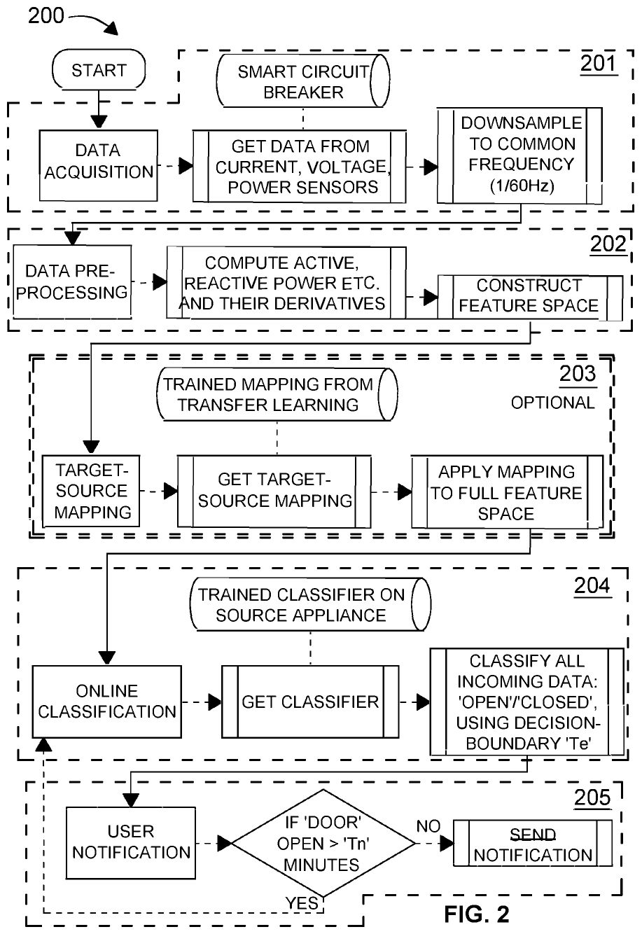

FIG. 1 is an example schematic diagram 100 of the system components for determining the temperature state change of a refrigerator appliance 101. The refrigerator appliance 101 may be any other cold storage-type enclosure as listed throughout this document. There are 3 main components of the system 100 that are required in order for the temperature state to be detected. These are the appliance 101, a computing component 102 and a user 103. The appliance 101 part of the system comprises a compressor and a circuit breaker. The compressor provides the means for cooling the appliance, and the circuit breaker controls and monitors the current and voltage being supplied to the compressor. The system 100 further comprises an acquisition component for acquiring the current and voltage data from the circuit breaker. The acquisition component is preferably part of the circuit breaker, for example a smart circuit breaker coupled to the appliance 101, but can also be an external device connected into the circuit breaker in order to acquire the data. The data is acquired via a plurality of power sensors which are configured to measure the power of the compressor. The computing component 102 of the system, which is external to the refrigerator appliance 101 and may be situated at an edge device or remote server, comprises a pre-processing module, a classifier module and a notification module. The computing component 102 is configured to carry out the aforementioned method steps as described in relation to the flow diagram 200 of FIG. 2. The computing component 102 comprises a communication component to facilitate the transmission of data to an external device or remote database. When a temperature change is detected the computing component 102 notifies the user 103 of such occurrence. The notification may be an electronic message sent to a device associated with the user 103 or may be the sounding of an alarm or the turning on of a light, or the like. Alternatively, when a temperature change is detected, a mechanical means may be provided to reseal the enclosure without the need for the user 103 to manually correct the fault that is causing the temperature change. The user 103 may still be notified in addition to providing a mechanical means to reseal the cold enclosure. In such embodiments the user 103 may be notified when a temperature change has been detected and again when the mechanical means has corrected the fault.

FIG. 2 is a flow diagram of the method steps according to an aspect of the disclosure. The method starts by acquiring data as shown in step 201 of the flow diagram 200 of FIG. 2. The data is read and acquired 201 from the compressor-driven appliance 101, such as a refrigerator. The data may include power data and/or energy data. The data is collected 201 from current, voltage and/or power sensors of a circuit breaker at the outlet of the appliance 101. These circuit breakers are integrated as part of the appliance or refrigeration system 101, or are external as part of an overall domestic or industrial power architecture. Nevertheless, no external or additional active sensors are required to be added to the appliance, refrigeration system, or cooling environment 101. The data acquired is raw current and voltage data or if the circuit breakers are smart circuit breakers the data can be calculated power and/or energy data. The data is recorded as a time series in order to determine the cycle duration of the compressor, as the power varies in a cyclical nature in a compressor. Once the data is acquired 201, it is down-sampled to a common frequency, such as 1/60 Hz, as some components operate at different frequencies. Thus, it is more efficient to down-sample high frequency data to a low common frequency such that the data from all frequency operating components may compared and analysed.

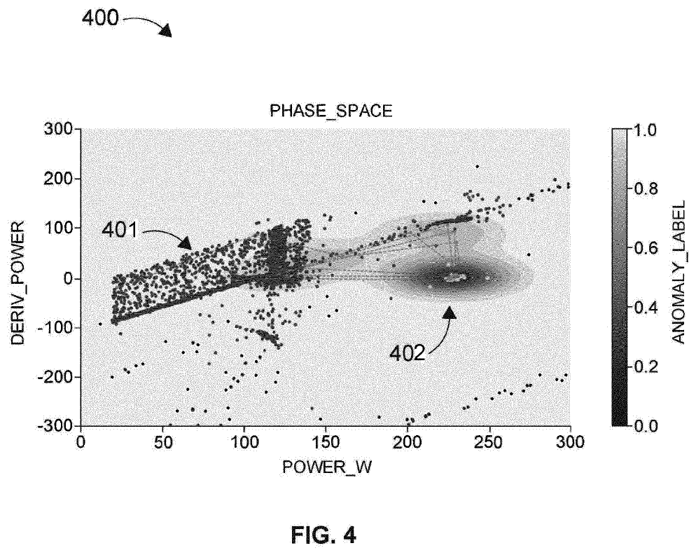

After acquiring the data, the next step 202 is data pre-processing as shown in the flow diagram 200 of FIG. 2. The data pre-processing 202 is performed in order to construct a feature space or 2D phase space map 400 to determine the temperature states of the refrigeration system. Details of the feature space 400 will be discussed in relation to FIG. 4. The pre-processing 202 of the collected data transforms the raw data collected from the sensors to power data, if not already acquired as power data, as described in step 201. Following the data pre-processing 202, the active power, reactive power and their derivatives are computed. From this the values of the power and power derivatives can be used to construct the feature space 400, wherein for each acquired data value a computed power data point will be added to the feature space 400. As more data is acquired 201 the density of data points in the feature space 400 increases such that common power values will create clusters in the feature space 400. Thus, these cluster values relate to common current/voltage states of the compressor. The feature space 400 is constructed 202 once the compressor of the particular refrigeration system (i.e. domestic appliance, chilled logistics or industrial cold storage) is in use or it may be developed beforehand during the manufacturing process of the particular refrigeration system.

Step 203 of the flow diagram 200 in FIG. 2 provides steps to map the features within the feature space 400. The mapping step 203, as shown in FIG. 2, is optional depending on if the feature space 400 was initially created during manufacturing or constructed while the compressor of the refrigeration system is in-situ. If the compressor of the refrigerator system has been tested and the feature space 400 has been developed during manufacturing, the mapping 203 will have already been performed and the features already correlated to temperature states of that particular refrigeration system. Thus, when the refrigeration system is in operation a feature space 400 is constructed 202 with the features already pre-mapped and temperature states identified. However, if the refrigeration system 101 is already in operation, i.e. an old refrigerator appliance, the mapping 203 of the features of the feature space 400 is implemented after constructing the feature space 202 as shown by the optional feature 203 in the flow diagram 200 of FIG. 2.

The mapping of the features 203 on the feature space 400 is achieved by applying a target-source mapping function to the feature space 400 as shown in FIG. 2. The target source function is mapped 203 on to the feature space 400 to help distinguish the differences between various appliances and compressor-based refrigeration systems. Each compressor-based appliance or system 101 may have different compressor cycles such that they have different cycle capacity, cycle length and/or cycle frequency. Therefore, it is important to distinguish between the different compressor cycles if the compressor-based appliance or system 101 is unknown, in order to determine if a temperature change has occurred. Thus, if the compressor is known this step 203 is not needed. As shown by the side database in step 203 of FIG. 2 the target source mapping function is trained as part of a separate transfer-learning procedure and inherited into the overall temperature change detection system 200. Details of the transfer learning procedure is discussed later. Once the trained target source mapping has been inherited into the temperature change detection system 203, it is applied to the full feature space 400 to determine the particular appliance or compressor-based refrigeration system 101. Acknowledging the particular appliance 101 type acts as a baseline from which the features in the feature space 400 can then be classified.

Following, either step 203 of applying the target source mapping to data of an unknown compressor or step 202 constructing the feature space 400 from data of a known compressor, the features of the feature map are then classified as shown in step 204 of FIG. 2. As new data is acquired (as a time series) and the temperature change detection system performs the necessary processing and mapping steps (201-203), traces through the feature space 400 are mapped such that any signal captured from the compressor lies within a threshold of recognised regions for that particular compressor and its power cycle. These regions are then classified by using a trained classifier which is stored at the source appliance or refrigerator system 101. The classifier may also be an online classifier where the classification is performed remotely. The classifier may be trained during the manufacturing stages of the compressor-based appliance or system 101, or it may be trained remotely once the appliance or system is in-situ. Once the classifier has been trained it can then be stored at the compressor source 101. As shown in step 204 of the flow diagram 200 of FIG. 2, all incoming data is classified using the trained classifier and the temperature state of the compressor is determined. The classifier can determine from the data points of the feature space different temperature states and classify regions of the feature space with a particular temperature state. From this the nature of the compressor-based appliance or system 101 can be determined, for example steady power cycle may correspond to a low temperature state which in turn corresponds to cold enclosure sealed whereas a sharp increase in power may correspond to an increase in power and thus an increase in temperature which in turn indicates a breach in the sealed cold enclosure. Further, the classifier can determine whether the incoming data lies within a determined threshold or decision-boundary (Te) of a region of the feature space, and thus determine when there is a change in temperature state. If one or more data points lie within the threshold of the region assigned as “breach of seal” or the like, then the temperature change detection system will notify a user of such occurrence.

In the final step 205 of the method steps of the flow diagram 200 in FIG. 2, the temperature detection system notifies one or more users to the change in temperature state if a change in temperature has occurred such that the incoming data is within a threshold as outlined in step 204. If no change in temperature is determined the one or more users are not notified. As the measured data is acquired as a time series, a predetermined time threshold may be selected such that the one or more users are only notified after a certain period of time has passed. It will be realised by the skilled person that the notification can take many forms in order to gain attention of a user and/or correct the change in temperature state. As such, notifying a user that a temperature change has been detected may comprise sending an electronic message to an external device such as a mobile device or remote computing device. It may also comprise sounding an alarm, turning on a light and/or providing a mechanical means to reseal the cold enclosure and regain the original temperature state. Providing a mechanical means to reseal the cold enclosure has the advantage that a user does not need to go to the location or site of the cold enclosure. This is especially advantageous if the cold enclosure is in a remote or hazardous location.

Thus, the flow diagram 200 of FIG. 2 represents a temperature change detection method with a compressor. The method comprises acquiring, via a circuit breaker of the compressor, power data associated with the compressor, wherein the power data relates to temperature states of the compressor. The method further comprises constructing a feature space using the acquired power data, determining feature vectors within the feature space, and classifying, via a classifier, the temperature states based on the feature vectors of the feature space. The method furthermore comprises determining a temperature change based on the classified temperature states; notifying a user of a detected temperature change.

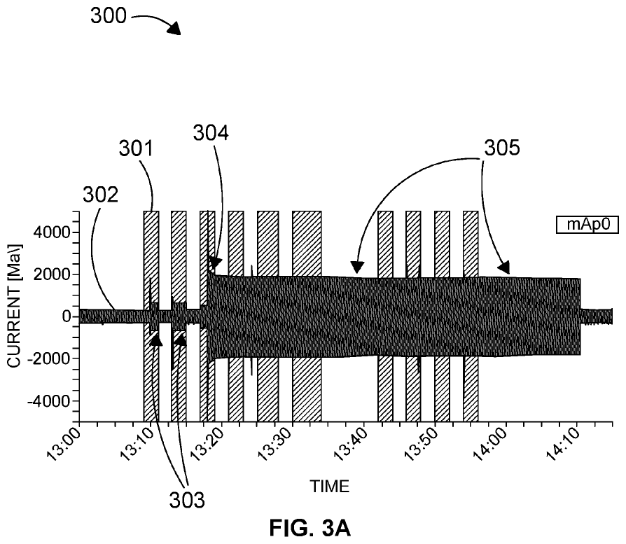

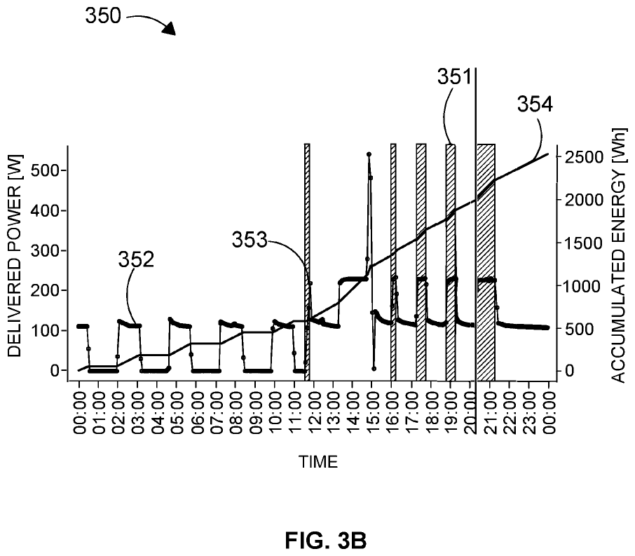

FIG. 3A is a plot 300 of current over time for a refrigerator appliance 101 where the temperature state has been deliberately changed in order to correlate the change in temperature state with the compressor load. In this example the current is AC and the time in which the current was acquired from the compressor is 1 hour and 15 minutes, i.e. from 13:00 to 14:15. The highlighted regions 301 in FIG. 3A reflect the times at which the door to the refrigerator appliance 101 was left open. As mentioned previously, opening the door of a cold enclosure or breaching the sealed enclosure changes the temperature state from a low temperature state to an increased temperature state due to the external higher temperature leaking into the cold enclosure. In the example in FIG. 3A the door was intermittently left open for varying lengths of time over the recorded test duration. The measured current, and thus the calculated power, is shown on FIG. 3A as higher than the baseline 302 of the operating current of the compressor when the temperature state changes due to the door opening. The increase in acquired current is shown at 303 in FIG. 3A, i.e. when the temperature state changes. A significant increase in measured current (almost +/−2000 mA), and thus power consumption, is found when the refrigerator door has been opened several times within a short period (approximately 10 minutes) or has been left open for a significant amount of time, i.e. >10 minutes, as shown at 304 in the plot of FIG. 3A. Further, shown in FIG. 3A once the compressor has increased the operating current and is drawing more power, in this example after the 3^{rd} door opening, it maintains a significant high current for a time after the event, as shown at 305 in FIG. 3A. Thus, the quicker the door is closed or cold enclosure is resealed, or the fewer times the seal is breached, the less power being consumed in the higher power state. Therefore, providing a user with a notification once the change in temperature state has been detected allows the user to correct the fault, such as closing the door or resealing the enclosure, and in turn save power and energy. The closing of the door or resealing a cold enclosure may be performed using mechanical means.

FIG. 3B is a plot 350 of the power over time for a refrigerator appliance 101 where the temperature state changes. The plot 350 shows the power delivered to the compressor over 24 hours. Similar to plot 300 of FIG. 3A, the highlighted regions 351 in FIG. 3B also relate to the times at which the door to the refrigerator appliance was left open. In the first 11 hours, i.e. from 00:00 to 11:00, the compressor of the refrigerator appliance is operating under closed door conditions with no external interferences or induced change in temperature state. The compressor during this time has a regulated power cycle, indicative of the cyclic operations of a compressor as shown by the waveform at part 352 of FIG. 3B. The compressor maintains the same cycle capacity, i.e. approximately 120 W peak power for approximately 70 minutes, and full cycle length, i.e. period of approximately 150 minutes, as shown by the recorded waveform 352. Different types of refrigerator appliances or cold enclosure systems 101 can have different compressor operating power cycles, thus it is important to determine the baseline cyclic operating characteristics of the compressor in order to be able to distinguish the differences in temperature state. As discussed in relation to step 203 of FIG. 2, if the power characteristics of the compressor are unknown a feature space can be created to determine the different power states of the compressor. These features are then mapped to correlate to the different temperature states of the compressor.

At the first door opening of the refrigerator appliance 101 under test 353 in FIG. 3B, occurring at just before 12:00, there is seen a sharp increase in delivered power to approximately 220 W. The power drops after closing the door. The designed process/solution can detect a door left opened starting from 15 mins after the door was left opened but does not resume back to 0 W. Rather, it settles at approximately 120 W with a slight decrease in power over the remainder cycle period, i.e. until just after 13:00. The compressor continues its cyclic behaviour from just after 13:00, but this time with the cycle capacity between 120 and 220 W and the cycle length increased from approximately 150 minutes to approximately 210 minutes, with the peak of the cycle increased from approximately 70 minutes to approximately 90 minutes. Each subsequent opening of the door increases the delivered power and extends the period of the compressor cycle. The accumulated energy steeply increases every time the door is opened compared to the closed door operating state of the compressor in the first half of the plot 350. This is clear in the change in gradient of the accumulated energy line 354 over the 24 hours. Further, as the compressor does not return to 0 W during its cycle after the door has been opened and then closed, the accumulated energy continues to rise even after the door is closed.

Therefore, measuring this change in power state can reflect back to the change in temperature state, with the increased delivered power to the compressor relating to the increase in temperature within the refrigerator appliance or cold enclosure system 101. Thus, indicating that a door is opened on a refrigerator appliance or there is a leak in the seal of a cold enclosure. Providing a user with a notification once the change in temperature state has been detected, from the power measurements, allows the user to correct the fault, such as closing the door or resealing the enclosure, and in turn save power and energy. As mentioned above, the closing of the door or resealing a cold enclosure can be performed using mechanical means. Implementing a mechanical means could save time over manually correcting the fault and thus, more power and energy. As is illustrated in FIG. 3B, the longer the door is open the more accumulated energy is consumed even after the door has been closed.

FIG. 4 illustrates a feature space plot 400 constructed from the power data of a refrigerator appliance 101 showing different temperature states. As described in relation to the method step 202 the feature space is constructed from the values of the power and power derivatives of the associated compressor data, wherein for each acquired data value a computed power data point will be added to the feature space. The computed data points 401 are shown in the feature space plot 400, with the clustered data points associated with different power states of the compressor and thus different temperature states. When the power increases from the “closed door” compressor power state (which in this example is a periodic cycle between 0 W and approximately 120 W) and the derivative power is approximately zero the data points in this region of the feature space correspond to an “open door” compressor power state. The increase to a specific power level for a given compressor type, i.e. the first condition, can be determined through experiment and/or data training. The second condition, where the derivative power is approximately zero indicates that such a state is stable over time. Thus, if the power has increased and the power state is stable, i.e. the two conditions are met, it is indicative of an “open door” state.

These are highlighted in the feature space plot 400 at region 402 of FIG. 4. As discussed in relation to the method steps, the feature space is mapped such that the “closed door” and “open door” regions are classified and that any power data acquired from the compressor lies within a threshold of these regions in order to be classified as a particular compressor and/or temperature state. The threshold for the “open door” state is indicated by the aura around the region of data points at 402 of FIG. 4, thus the data points lying within this aura will be classified as an “open door” state and a notification will be sent to alert the user. It will be realised by the skilled person that additional temperature states may be classified depending on the application and functions of the compressor. And these further states will be defined by a region of the feature space with a particular threshold. As discussed with respect to the method steps of FIG. 2, the regions are classified using a trained classifier and the thresholds predetermined by the user.

For an unknown refrigerator appliance or cold enclosure system 101 the feature space, like the example in FIG. 4, would be adapted such that the feature space of an unknown appliance (referred to as target space) is mapped to the feature space of a known appliance (referred to as source space). This target-source mapping is an optional step in the overall method steps, as outlined at step 203 of the flow diagram 200 of FIG. 2, as it is only required if the appliance or cold system 101 is unknown. The mapping of the target space to the source space is performed through transfer learning and domain adaptation. For the example disclosed here, it is sufficient to use a single classifier to map the target space to the source space, as the main goal is to determine the “open door” state of the refrigerator appliance or cold enclosure system 101. Further, this approach also preserves the power consumption characteristics between the different compressors.

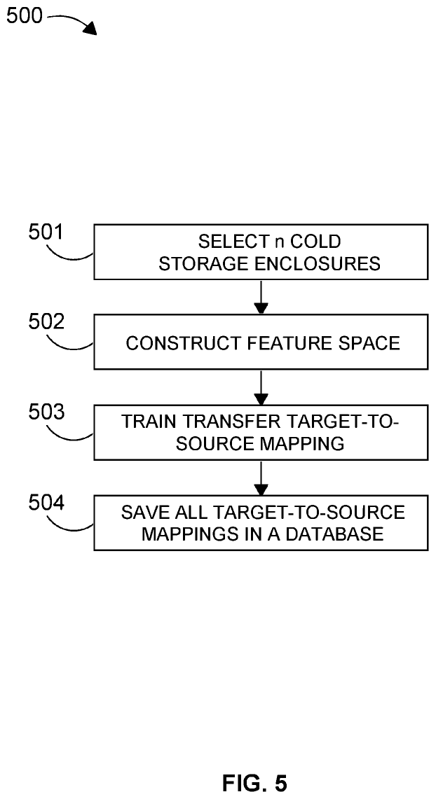

FIG. 5 is a flow diagram 500 of the transfer learning method steps for determining the temperature change state of an unknown refrigerator appliance 101. Step 501 is to select n cold storage enclosures such as domestic refrigerator appliances, industrial cool rooms, controlled storage environment and/or chilled logistics containers, which vary in size, power consumption, age, etc. Selecting a large number of different cold storage enclosures creates n categories, where the cold enclosures within each category have similar compressor characteristics. The next step 502 is to construct identical feature spaces for all the selected cold storage enclosures, i.e. a feature space is constructed for each n categories of cold storage enclosures. Step 503 comprises training transfer mapping from target cold storage enclosure to the source cold storage enclosure. Every new cold storage enclosure will have its own target-to-source mapping function Q learned from purely unlabelled time series data. The mapping function Q is achieved by using a self-predictive model or using common representation learning. All the target-to-source mappings Q1, . . . , Qn are then saved into a database as in step 504 of the flow diagram 500 of FIG. 5. If a new unknown cold storage enclosure is recorded it is assigned to the closest cold storage enclosure category, as saved in the database, and the target-to-source mapping is performed using the closest mapping function Q. Thus, the new unknown cold storage enclosure will be able to notify a user if there is breach in the seal of the enclosure or if the door has been left open once the features of the feature space have been mapped and classified.

It will be appreciated that the above described embodiments of the present invention are given by way of example only, and that various modifications may be made to the embodiments without departing from the scope of the invention as defined in the appended claims.

It will be realised that the feature space may be constructed from energy and energy derivative values instead or in addition to the power feature space, depending on the information to be extracted. Further, the feature space may include voltage and current as well as engineered features such as power spectral density.

1. A temperature change detection method with a compressor, the method comprising:
acquiring, via a circuit breaker of the compressor, power data associated with the compressor,
wherein the power data relates to temperature states of the compressor;
constructing a feature space using the acquired power data;
determining feature vectors within the feature space;
classifying, via a classifier, the temperature states based on the feature vectors of the feature space;
determining a temperature change based on the classified temperature states; and
notifying a user of a detected temperature change.

2. The method of claim 1, wherein the compressor is part of a refrigeration system.

3. The method of claim 2, wherein the refrigeration system is part of a cold enclosure.

4. The method of claim 1, wherein the acquisition of power data of the compressor comprises acquiring one or more of:
current data;
voltage data;
calculated power data; and/or
calculated energy data.

5. The method of claim 1, wherein the power data is pre-processed before constructing the feature space, wherein pre-processing comprises determining the active power, reactive power and/or derivative power.

6. The method of claim 1, wherein the classifier is an online classifier.

7. The method of claim 1, wherein determining if a temperature change has occurred relates to a breach in a seal of a cold enclosure.

8. The method of claim 1, wherein the notification is executed after a predetermined time threshold.

9. The method of claim 8, wherein the predetermined time threshold is defined by a user.

10. The method of claim 1, wherein notifying a user that a temperature change has been detected, comprises:
sending an electronic message to an external device;
sounding an alarm;
turning on a light; and/or
providing mechanical means to reseal the cold enclosure.

11. A temperature change detection system, the system comprising:
a compressor;
a circuit breaker of the compressor;
an acquisition component;
an external computing component, wherein the external computing component is configured to:
acquire, via the circuit breaker of the compressor, power data associated with the compressor,
wherein the power data relates to temperature states of the compressor;
construct a feature space using the acquired power data;
determine feature vectors within the feature space;
classify, via a classifier, the temperature states based on the feature vectors of the feature space;
determine a temperature change based on the classified temperature states;
notify a user of a detected temperature change.

12. The system of claim 11, further comprising a plurality of power sensors,
wherein the plurality of power sensors are configured to measure the power data of the compressor.

13. The system of claim 11, further comprising a communication component,
wherein the communication component is configured to transmit the power data to an external device.

14. The system of claim 11, wherein the external computing component is an edge device or a remote server.

15. The system of claim 11, wherein the external computing component comprises:
a pre-processing module;
a classifier module;
a notification module.
